(19) United States
(12) Patent Application Publication
(10) Pub. No.: US 2020/0284363 A1
(43) Pub. Date: Sep. 10, 2020

(54) AXIAL FLOW CHECK VALVE

(71) Applicant: Storm Manufacturing Group, Torrance, CA (US)

(72) Inventors: Abraham Dorantes, Glendale, AZ (US); Bogumil J. Matysek, Lomita, CA (US); Andy Freyer, Playa Del Rey, CA (US)

(21) Appl. No.: 16/297,618

(22) Filed: Mar. 9, 2019

(51) Int. Cl. F16K 15/02; F16K 27/02; F16K 31/12

(52) U.S. Cl. CPC F16K 15/026; F16K 31/12; F16K 27/0209

(57) ABSTRACT

A check valve employs a valve body with an inlet portion having integrated first threads to engage an inlet pipe fitting and an outlet portion having integrated second threads to engage an outlet pipe fitting. The valve body has an internal chamber with a plurality of longitudinal flanges extending radially inward, the longitudinal flanges forming axial flow channels therebetween. Each longitudinal flange terminates at a radial flange having a sealing face. A poppet having a cylindrical outer surface with a first diameter is configured for sliding engagement of a guide surface on a radial inner extent of each of the plurality of longitudinal flanges and a sealing surface configured to mate in a closed position with the sealing face of the radial flange. A spiral spring urges the poppet to the closed position. A retainer constrains the spiral spring and has a plurality of spokes with open sectors between the spokes aligning with the axial flow channels.

### BACKGROUND INFORMATION

### Field

Embodiments of the disclosure relate generally to compressed air applications and more particularly to check valves having high axial flow capability and directly insertable into a flow line.

### Background

Plumbing systems, particularly in industrial applications, often have long straight sections of piping in which minimal diametric variation and complexity is desirable and very short sections of piping in which a minimum length and clearance radius are available. Check valves for these applications typically require significant additional radius or length to accommodate required flows.

It is therefore desirable to provide an axial flow check valve which provides maximum axial flow but is insertable directly into even a very short section of pipe with minimal added circumference relative to the pipe.

### SUMMARY

Embodiments disclosed herein provide a check valve employing a valve body with an inlet portion having integrated first threads to engage an inlet pipe fitting and an outlet portion having integrated second threads to engage an outlet pipe fitting. The valve body has an internal chamber with a plurality of longitudinal flanges extending radially inward, the longitudinal flanges forming axial flow channels therebetween. Each longitudinal flange terminates at a radial flange having a sealing face. A poppet having a cylindrical outer surface with a first diameter is configured for sliding engagement of a guide surface on a radial inner extent of each of the plurality of longitudinal flanges and a sealing surface configured to mate in a closed position with the sealing face of the radial flange. A spiral spring urges the poppet to the closed position. A retainer constrains the spiral spring and has a plurality of spokes with open sectors between the spokes aligning with the axial flow channels.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

FIGS. 1A and 1B are pictorial views from an opposite perspectives of an exemplary implementation of the axial flow check valve

FIGS. 2A-2C are top, bottom and side views of the exemplary embodiment;

FIG. 3 is a detailed pictorial representation of the exemplary implementation in ⅓ section along lines A-A of FIG. 2A;

FIG. 4A is a detailed pictorial representation of the exemplary implementation in ½ section along lines B-B of FIG. 2A;

FIG. 4B is a side section view of the exemplary implementation in ½ section along lines B-B of FIG. 2A;

FIG. 5 is a detailed pictorial section view of the valve body along lines C-C of FIG. 2B;

FIG. 6 is a side section view of the implementation in ½ section along lines B-B of FIG. 2A in the closed position;

FIG. 7 is a detailed pictorial view of the poppet; and,

FIG. 8 is a detailed pictorial view of the retainer.

### DETAILED DESCRIPTION

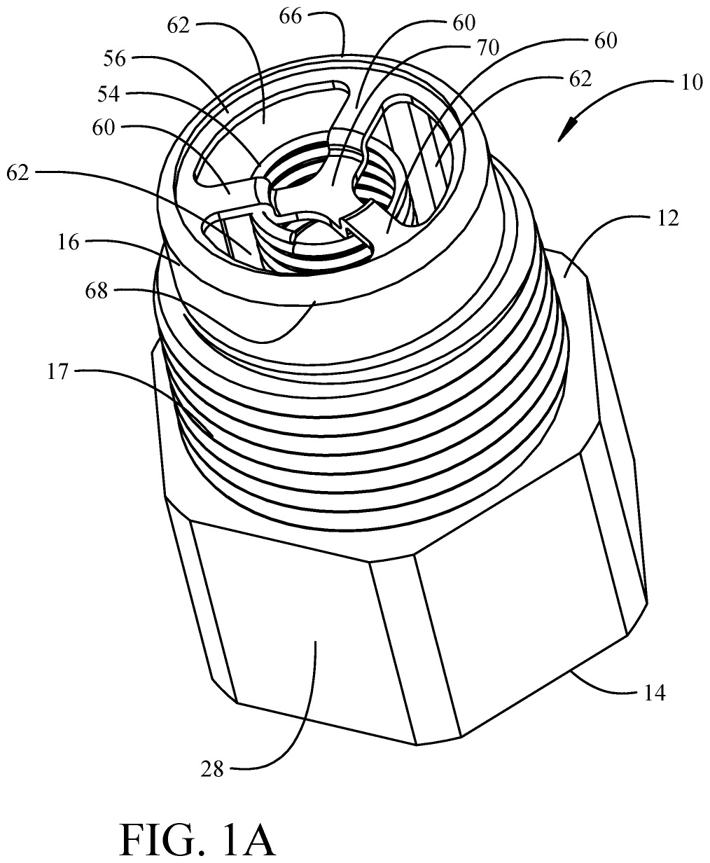

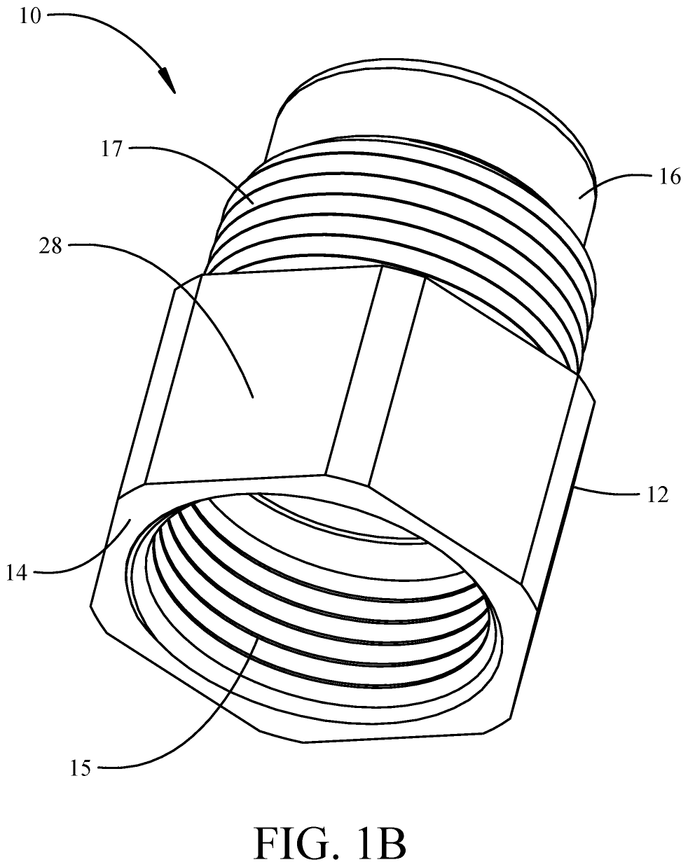

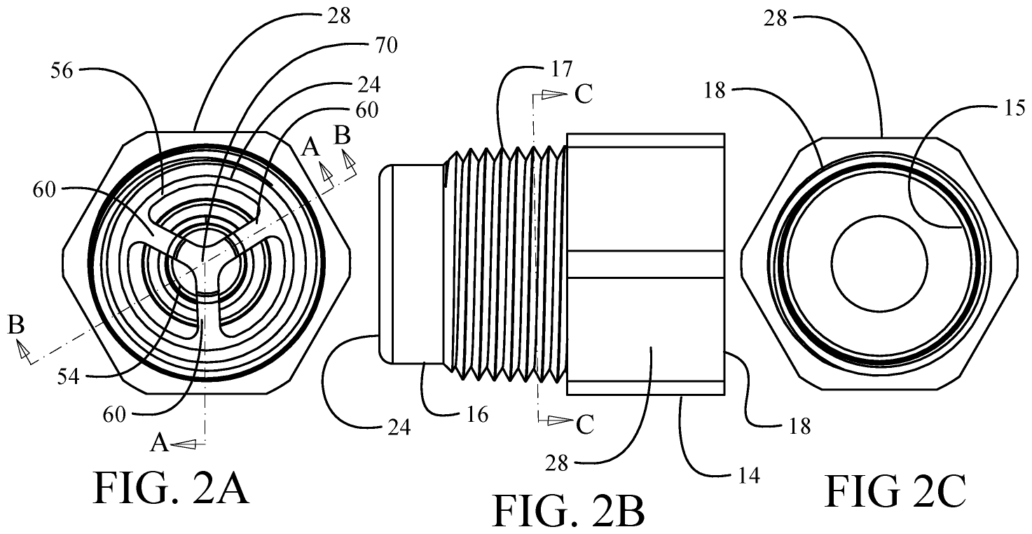

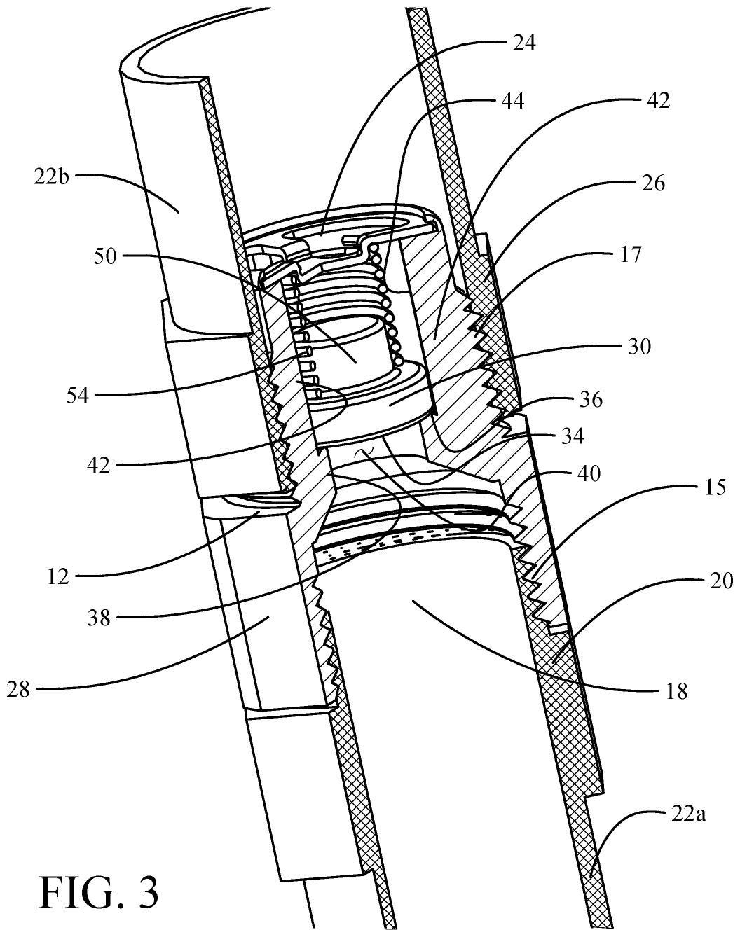

Implementations disclosed herein provide an axial flow check valve which may be inserted in a section of pipe with minimal diametric variation and minimal pipe transition length. Referring to the drawings, FIGS. 1A and 1B show pictorial views of an exemplary implementation of the axial flow check valve 10 with top, side and bottom views shown in FIGS. 2A-2C. The axial flow check valve 10 has a body 12 which includes an inlet portion 14 having first integrated threads (for the exemplary implementation internal threads 15) and an outlet portion 16 having second integrated threads (for the exemplary implementation external threads 17). As seen in FIG. 3, the inlet portion 14 includes an inlet aperture 18 and engages an inlet pipe fitting (a pipe nipple 20 for the exemplary implementation) on the upstream portion of a pipe 22a in which the axial flow check valve 10 is inserted while the outlet portion 16 has an outlet aperture 24 and engages a outlet pipe fitting (a threaded socket 26 for the exemplary implementation) in the downstream portion of the pipe 22b. The body 12 includes wrench flats 28. With this configuration, the axial flow check valve 10 has no greater diameter than any axial fitting applied to the pipe and therefore does not impact the overall diameter of a pipe run. The internal and external threads may be reversed for the first and second integrated threads on alternative implementations.

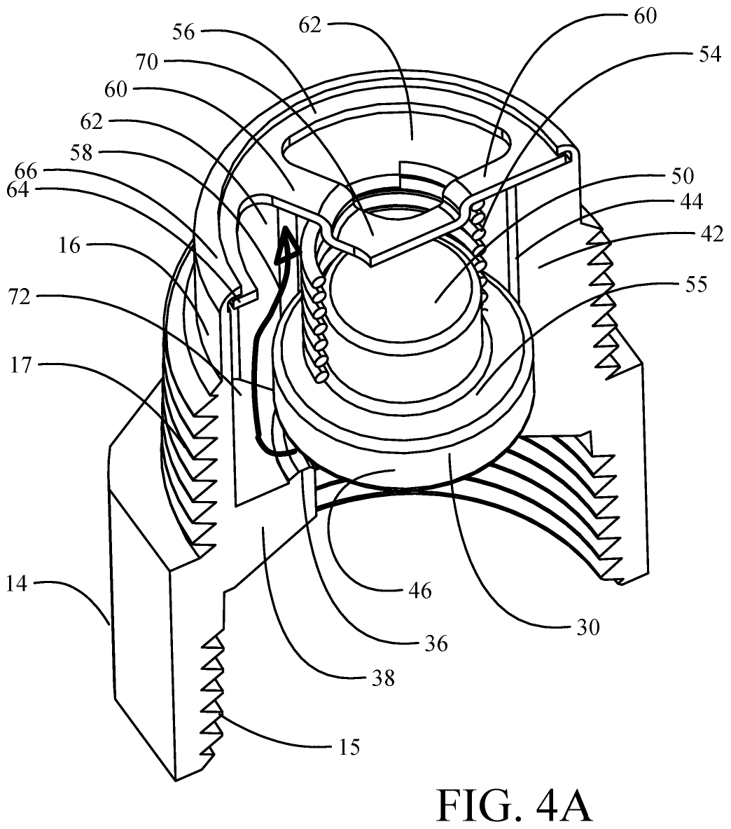

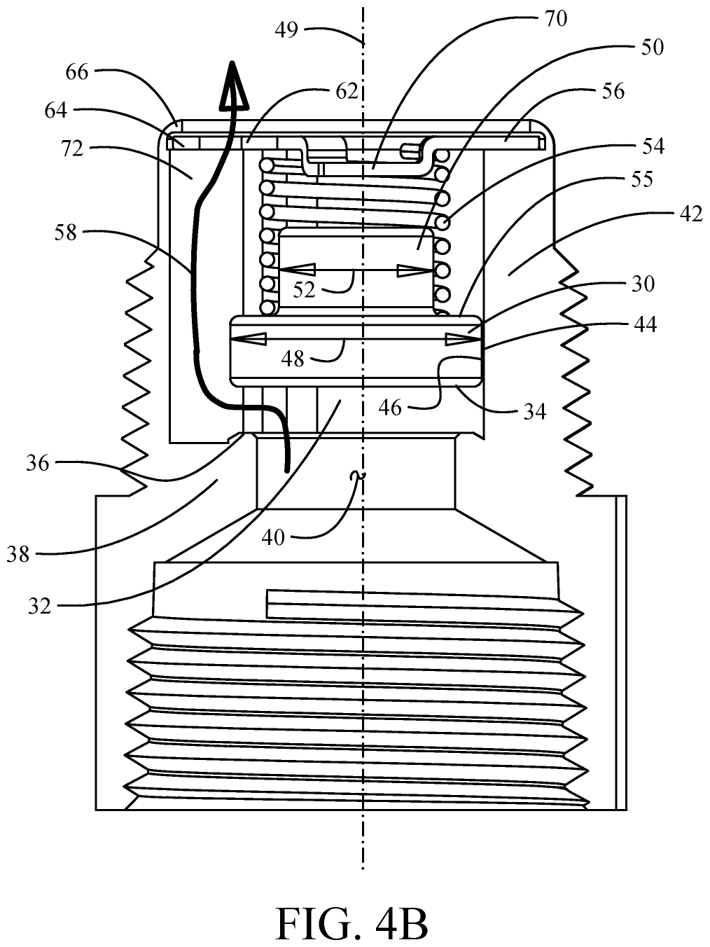

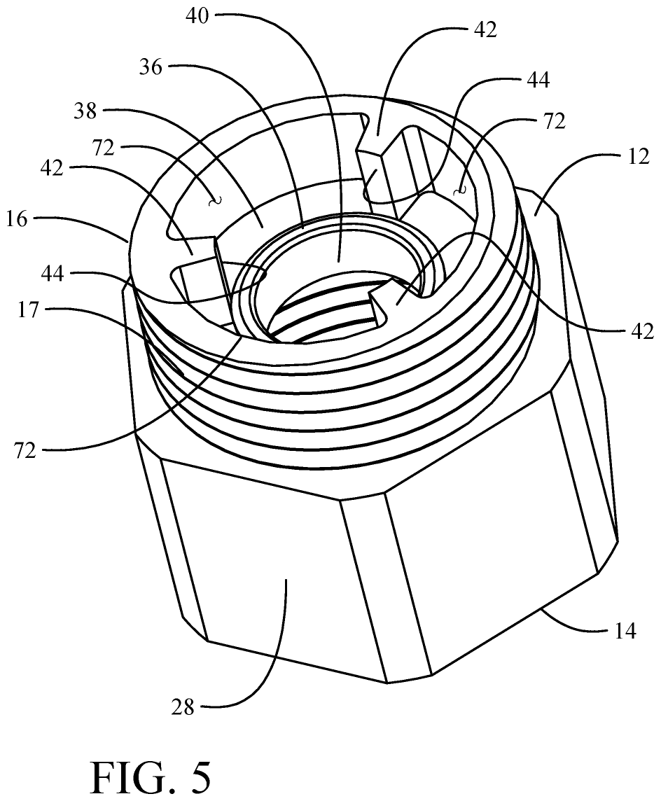

As seen in FIGS. 3 and 4A-4B the axial flow check valve 10 has a poppet 30 positioned in an internal chamber 32 in the body 12. The poppet 30 has a sealing surface 34 configured to mate on a sealing face 36 of a radial flange 38 in a closed position. The radial flange 38 is concentric to a flow orifice 40. The body 12 incorporates a plurality of longitudinal flanges 42 (three in the exemplary implementation) extending radially inward into to the chamber 32. Each longitudinal flange 42 has a guide surface 44 on a radial inner extent of the flange. The poppet 30 has a cylindrical outer surface 46 with a first diameter 48 having sliding engagement with the guide surfaces 44 which maintains the orientation of the poppet within the chamber 32 and alignment concentric to a longitudinal axis 49 of the axial flow check valve 10. Details of the longitudinal flanges and radial flange in the cavity in the body 12 of the axial flow check valve 10 can be seen in FIG. 5.

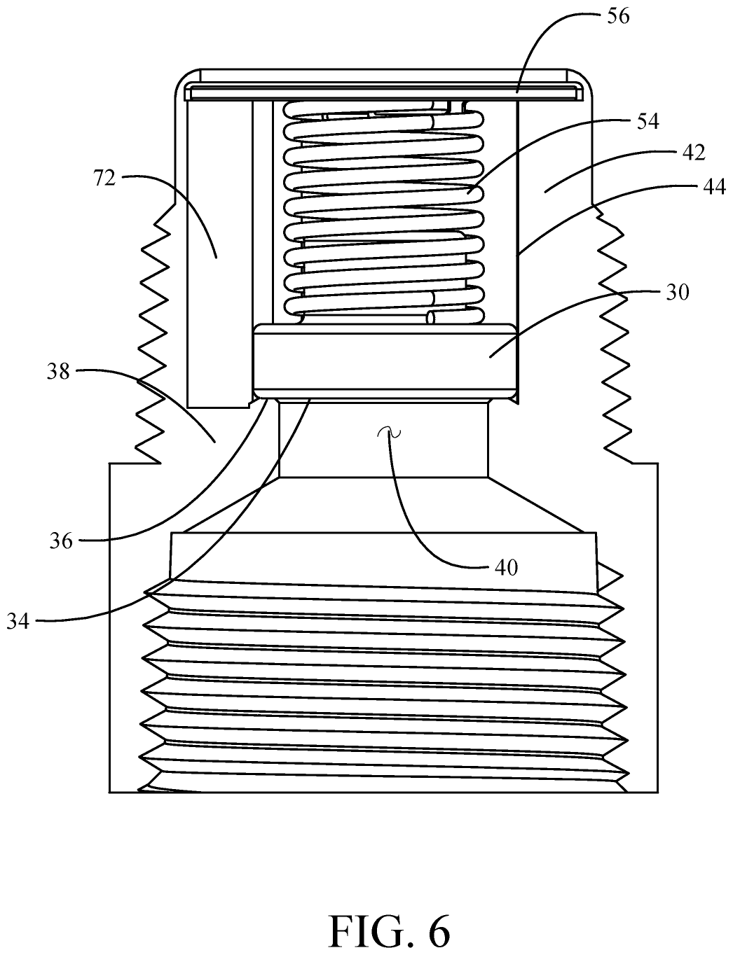

The poppet 30 has a cylindrical protrusion 50 with a second diameter 52 less than the first diameter 48 and concentric with the longitudinal axis 49. The cylindrical protrusion 50 is concentrically received in a spiral spring 54. The spiral spring 54 engages a shoulder surface 55 extending between the cylindrical protrusion 50 and the cylindrical outer surface 46 of the poppet 30 to resiliently urge the poppet 30 to the closed position as seen in FIG. 6. A retainer 56 is constrained in the outlet aperture 24 and engages the spiral spring 54 to react flow force against the poppet 30. The spiral spring is sized to compress under normal fluid flow through the axial flow check valve 10, represented by arrow 58, to allow the poppet 30 to be displaced to an open position.

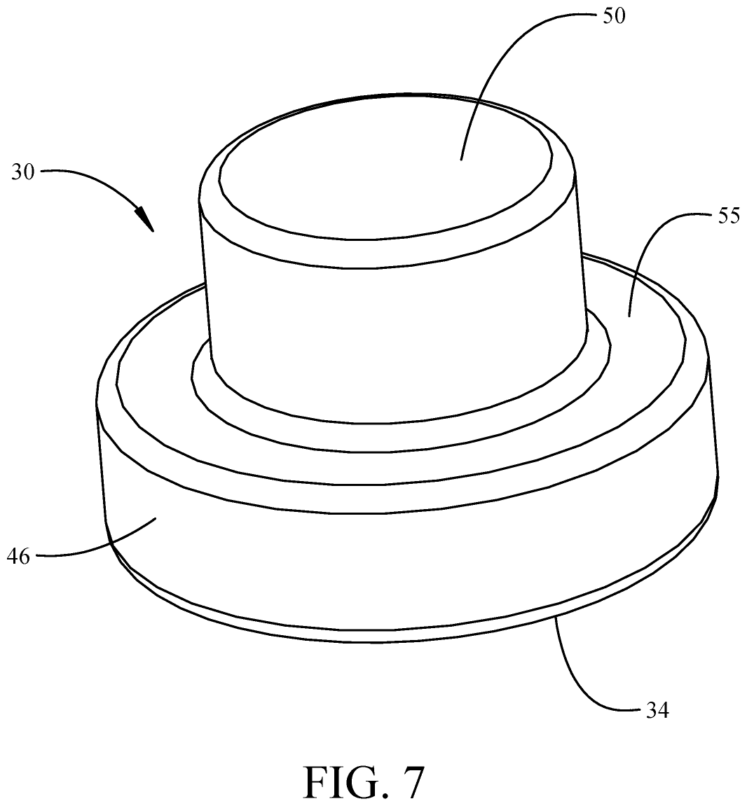

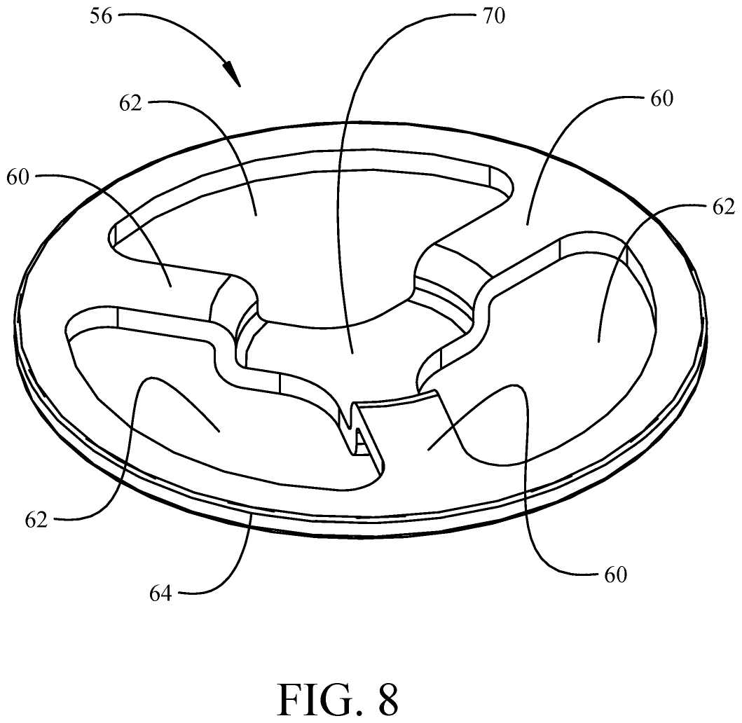

The retainer 56 has a plurality of radial spokes 60. For the exemplary embodiment the plurality of radial spokes is equal in number to and aligned with the plurality of longitudinal flanges 42. Open sectors 62 between the radial spokes 60 provide axial outlet flow from the axial flow check valve 10. A rim 64 of the retainer 56 is constrained in the outlet aperture 24 by a crimped lip 66 on a circumference 68 of the outlet portion 16. The spokes 60 extend inward from the rim 64 to a dimple 70 sized to be concentrically received in the spiral spring 54 to radially constrain the spiral spring and maintain alignment of the spring concentric to the longitudinal axis 49. While shown as extending inward or upstream in the exemplary implementation, the dimple 70 may extend outward or downstream. Details of the poppet and retainer 56 are seen in FIGS. 7 and 8.

The longitudinal flanges 42 form axial flow channels 72. In the open position as seen in FIGS. 3, 4A and 4B flow passes around the poppet 30 through the axial flow channels 72 and exits through the open sectors 62 on the retainer. In the exemplary implementation, the axial flow channels 72 are aligned with the open sectors 62 of the retainer 56 for uninterrupted axial flow. With any cessation of flow, spiral spring 54 urges the poppet 30 into the closed position engaging sealing surface 34 with the sealing face 36 on the radial flange 38 of the body 12 preventing any back flow through the axial flow check valve 10. Any additional back flow pressure is reacted by the shoulder surface 55 to further urge the sealing face 36 against the sealing surface 34 further enhance sealing of the poppet 30.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims.

What is claimed is:

1. A check valve comprising:
a valve body with an inlet portion having integrated first threads to engage an inlet pipe fitting and an outlet portion having integrated second threads to engage an outlet pipe fitting, the valve body having an internal chamber with a plurality of longitudinal flanges extending radially inward, said longitudinal flanges forming axial flow channels therebetween, and each longitudinal flange terminating at a radial flange having a sealing face;
a poppet having a cylindrical outer surface with a first diameter configured for sliding engagement of a guide surface on a radial inner extent of each of the plurality of longitudinal flanges and a sealing surface configured to mate in a closed position with the sealing face of the radial flange;
a spiral spring urging the poppet to the closed position; and,
a retainer constraining the spiral spring and having a plurality of spokes with open sectors between the spokes aligning with the axial flow channels.

2. The check valve as defined in claim 1 wherein the poppet has a cylindrical protrusion with a second diameter less than the first diameter and the spiral spring is received on the cylindrical protrusion, said poppet further having a shoulder surface extending between the cylindrical protrusion and the cylindrical outer surface, said spiral spring engaging the shoulder surface.

3. The check valve as defined in claim 2 wherein the spiral spring is concentrically received on the cylindrical protrusion.

4. The check valve as defined in claim 1 wherein the retainer has a dimple sized to be concentrically received in the spiral spring to radially constrain the spiral spring and maintain alignment of the spring concentric to the longitudinal axis.

5. The check valve as defined in claim 4 wherein the dimple extends inwardly.

6. The check valve as defined in claim 4 wherein a rim of the retainer is constrained in an outlet aperture by a crimped lip on a circumference of the outlet portion.

7. The check valve as defined in claim 1 wherein the plurality of spokes on the retainer is equal to the plurality of longitudinal flanges and each of said plurality of spokes is aligned with a respective one of the plurality of longitudinal flanges.

8. The check valve as defined in claim 7 wherein the axial flow channels are aligned with the open sectors of the retainer for uninterrupted axial flow.

9. The check valve as defined in claim 3 wherein upon cessation of flow the spiral spring urges the poppet into the closed position engaging sealing surface with the sealing face on the radial flange of the body thereby preventing any back flow.

10. The check valve as defined in claim 10 wherein any additional back flow pressure is reacted by the shoulder surface to further urge the sealing face against the sealing surface to enhance sealing of the poppet.
